(19) United States
(12) Patent Application Publication
(10) Pub. No.: US 2007/0216122 A1
(43) Pub. Date: Sep. 20, 2007

(54) Mobility Cart

(75) Inventors: Gregory T. Cornelius, Castro Valley, CA (US); Darrell S. Lavin, Castro Valley, CA (US)

Correspondence Address: BELL & ASSOCIATES, 416 FUNSTON ST., SUITE 100, SAN FRANCISCO, CA, 94118, US

(73) Assignee: Gregory T. Cornelius

(21) Appl. No.: 11/726,098

(22) Filed: Mar. 20, 2007

Related U.S. Application Data
(60) Provisional application No. 60/784,053, filed on Mar. 20, 2006.

(51) Int. Cl. B62M 1/00

(52) U.S. Cl. 280/87.05

(57) ABSTRACT

The invention is a mobility cart for a person having an injured or disabled lower limb for use in confined spaces, such as the home. Of particular note, the cart has three wheels and has a low center of gravity thereby improving the stability of the cart and rider.

The present application claims priority to U.S. Provisional Patent Application Ser. No. 60/784,053 entitled “Mobility Cart”, filed Mar. 20, 2006, which is herein incorporated by reference in its entirety for all purposes.

### FIELD OF THE INVENTION

The present invention is a wheeled or tracked mobility cart for use by individuals having lower limb injuries or disabilities. In particular the cart has a low center of gravity resulting in improved stability for both the cart and the rider.

### BACKGROUND OF THE INVENTION

Injury to a lower limb, such as a broken ankle, a broken tibia, and other such fractures, usually result in a sever reduction in mobility for a person. In general, the period for recovery can last up to six or even eight weeks, and the injured person may remain housebound for much of that period. The most preferred method for assisting mobility in such cases is through the use of crutches, which are simple to use and easy to produce at a low cost. Under some circumstances, the physician may prescribe a wheelchair, however unless the house is correctly configured this can be cumbersome and sometimes impossible to use with any efficiency. Unfortunately both the crutch and the wheelchair can actually limit a person's functioning abilities as well as induce frustration at being unable to perform usually simple tasks routinely. Crutches, for example, require that the person support themselves using their hands, thereby preventing them from being able to carry things through the home. A person in a wheelchair is at a disadvantage in that the counters and home appliances are generally designed to be used by a fully upright person and not by one in a sitting position.

There therefore remains a need for a device or means that can be used by such a person that can assist their mobility in the home.

### PRIOR ART

Various self-propelled carts, scooters, walkers, etc. for the locomotion of a person who has one non-ambulatory lower leg and one ambulatory leg are known. Typically, the person rests his or her non-ambulatory lower leg on a surface supported by a wheeled frame, while using his or her ambulatory leg for propulsion.

A problem with such devices has been their instability. In short, they have been undesirably prone to tipping over during operation. Another problem with such devices has been their lack of versatility. Devices made specifically for a person having a non-ambulatory lower left leg have not been suitable for a use by person having a non-ambulatory lower right leg, and vice-versa. Prior devices have not fully addressed both of these issues.

For example, U.S. Pat. No. 5,800,317 issued on Sep. 1, 1998 to Accetta discloses a four-wheeled walker having handlebars with a side extension that serves as an outrigger to give the wheels of the walker an asymmetrical arrangement relative to a center axis of the vehicle. Accetta is directed to the instability problem, but the walker that Accetta teaches lacks versatility, as it is dedicated to either a left or a right leg and would be cumbersome to use around the home.

U.S. Pat. No. ______ issued on Feb. 1, 2005 to Miller discloses a four-wheeled cart having a leg support means and handlebars for steering the cart. The disclosure also describes an additional braking means on the handlebars suggesting that the device was conceived for use outside the home. Using the cart disclosed by Miller in the home would likely have similar limitations as a wheelchair.

U.S. Pat. No. 5,839,740 issued on Nov. 24, 1998 to Seeger discloses a three-wheeled cart having handelbars. The two front wheels of the cart are fixed. The rear (third) wheel is attached to a leg support assembly that is configured to be attached to either a left or a right side of the cart. This allows reconfiguration of the cart to accommodate either a left or a right leg, and Miller perceives this three-wheeled cart to be inherently less stable than the four-wheeled vehicle as disclosed by Miller.

Several other patents and publications also appear to address the problem of stability. U.S. Pat. No. 4,239,248, issued on Dec. 16, 1980 to Ewers shows a three-wheeled collapsible walker, with a smaller rear wheel. The central seat is not designed to support an injured leg in a cast. U.S. Pat. No. 4,861,051, issued on Aug. 29, 1989 to Napper discloses a rehabilitation walker device having four small wheels. As with the Ewers' device, the central seat is not designed to support an injured leg in a cast. U.S. Pat. No. 5,167,597, issued on Dec. 1, 1992 to David, teaches a wheeled walker treatment method wherein a scooter-type walker supports the majority of an individual's weight as they walk. A leg support assembly that can be moved to either side of the walker is not disclosed. U.S. Pat. No. 5,411,035, issued on May 2, 1995 to Stone, shows an orthopedic wheeled leg support including a handlebar and five small caster-type wheels. The support cannot be repositioned from one side of the walker to the other, and is somewhat unstable in design. U.S. Pat. No. 5,427,391, issued on Jun. 27, 1995 to Cooper discloses pivoted knee skates. The skates include a leg and foot rest, a plurality of wheels and a securement mechanism for the legs and feet. U.S. Pat. No. 6,053,189, issued on Apr. 25, 2000 to Longenecker et al. discloses a device including a wheeled base (and a plurality of wheels), a leg support member, and a handle for steering. A preferred embodiment discloses four caster wheels and a fifth balancing caster wheel.

U.S. Pat. No. 4,867,188, issued Sep. 19, 1989 to Reid discloses and claims a trolley having a support structure mounted in a sleeve having legs mounted on castors or rotatable wheels, and a maneuvering handle. Reid claims a plurality of wheels and the drawings disclose a device having four wheels.

British Patent Specification No. 881,450, to Hallewell, published Nov. 1, 1961, describes a vehicle for transporting invalids. This device includes a seat for the individual, three wheels and a handle for operation control. French Patent Publication No. 2,412,453, to Reinhard, published Aug. 20, 1979, describes a scooter propelled by a rider that has a cushion on which the user sits or kneels. This scooter has a standard handlebar for operation control.

None of the above inventions and patents, taken either singularly or in combination, is seen to describe the instant invention as claimed. Thus a mobility cart for injured persons solving the aforementioned problems is desired.

### SUMMARY OF THE INVENTION

The present invention provides a mobility cart for use by a person having a injured or disabled limb. In one embodiment the mobility cart comprises a frame, a limb support member coupled to the frame, the frame having a front end and a rear end, and a plurality of wheels coupled to the frame. In a preferred embodiment the mobility cart has a low center of mass. In another preferred embodiment the mobility cart has at least three wheels. In a more preferred embodiment, the diameter of each wheel is selected from the group consisting of 2 inches, 2.5 inches, 3 inches, 3.5 inches, 4 inches, 4.6 inches, 5 inches, 6 inches, 7 inches, 8 inches, 9 inches, and 10 inches. In a most preferred embodiment the diameter of each wheel is 5 inches. In one preferred embodiment, the wheels are sealed bearing wheels. In another embodiment the limb support member further comprises an adjustable bracket and a padded limb support cover. In a still further embodiment the mobility cart further comprises a bracket interposed between the frame and the limb support member. In another preferred embodiment the limb support member comprises a knee support. In another embodiment the limb support member comprises a telescoping support and a sleeve. In a more preferred embodiment the mobility cart further comprises a handle, the handle fixedly attached to the knee support.

In another embodiment the invention provides a mobility cart further having at least one outrigger coupled to the frame.

In a yet further embodiment the invention provides a mobility cart having three wheels and wherein two wheels are mounted at the front end of the frame and one wheel is mounted at the rear end of the frame. In a preferred embodiment each of the two wheels at the front end of the frame are further mounted on a caster attached to the frame. In another preferred embodiment the wheel mounted on the rear end of the frame is mounted on an axel attached to the frame. In an alternative embodiment each of the two wheels at the front end of the frame are mounted on an axel attached to the frame.

In a still further embodiment the invention provides a mobility cart as disclosed herein wherein the frame comprises a cross frame and a base frame. In one preferred embodiment the cross frame is oblong. In another alternative preferred embodiment the cross frame comprises an “I” shape. In yet another alternative preferred embodiment the cross frame comprises a “V” shape. In a still further alternative preferred embodiment the cross frame comprises a “U” shape. In another alternative preferred embodiment the cross frame comprises an “O” shape. In a yet further alternative preferred embodiment the cross frame comprises a “gull-wing” shape.

The invention also alternatively provides a mobility cart as disclosed herein, wherein the cross frame comprises an oblong bar having at least two apertures. The base frame comprises at least one slot, the slot shaped and adapted for receiving retaining means. The retaining means can be threaded, such as a screw or a bolt, can be an expandable and/or retractable ring assembly, or the like. The cross frame is reversibly fixedly attached to the base frame using the retaining means. The retaining means is passed through an aperture in the cross frame, entered into the slot and tightened, thereby attaching the cross frame to the base frame. In one preferred embodiment the retaining means further comprise a knob for manual adjustment by a rider or user. The manual adjustment allows a rider or user to tighten or loosen the retaining means and thereby either ensure a tight fit attachment between the cross frame and the base frame, or to allow the rider or user to un-attach the cross frame from the base frame.

The invention further provides a method for supporting and mobilizing a person having a lower limb impairment, the method comprising the steps of (i) providing a mobility cart as described herein, (ii) placing the impaired lower limb of the person upon the limb support member, (iii) pushing the mobility cart using an un-impaired lower limb, thereby supporting and mobilizing the person having a lower limb impairment.

### BRIEF DESCRIPTION OF THE FIGURES

FIG. 1 illustrates one embodiment of the invention in a three-quarters view. In this illustration, the limb support member of the mobility cart is in a raised position.

FIG. 2 illustrates the limb support member of the mobility cart in an inclined position.

FIG. 3 illustrates the mobility cart from an overhead view.

FIG. 4 illustrates an alternative embodiment comprising caterpillar tracks.

FIG. 5 illustrates a cross section of the cross bar having a “V” shape.

FIG. 6 illustrates a cross section of the cross bar having a “U” shape.

FIG. 7 illustrates one embodiment of a portion of the invention in a three-quarters view showing the outrigger.

FIG. 8 shows a portion of an alternative embodiment of a wheel coupled to the frame using a fork and axel.

FIG. 9 illustrates an alternative embodiment showing the handle, angle adjustment bracket, hand-tightenable knobs for adjusting the cart configuration to be propelled by a user or rider's left or a right limb.

### DETAILED DESCRIPTION OF THE INVENTION

The invention is a mobility cart for assisting a person who is disabled and/or has an injury to a lower limb. The cart unit can be used by such a person instead of using crutches or a wheelchair, thereby freeing the hands. The cart can be used in the home and the office and is particularly useful where the person has to move about in confined spaces. The cart is an improvement over other carts and vehicles that have been disclosed and used in the past and overcomes the stability problems cited by others for a three-wheeled cart by virtue of having a low center of mass.

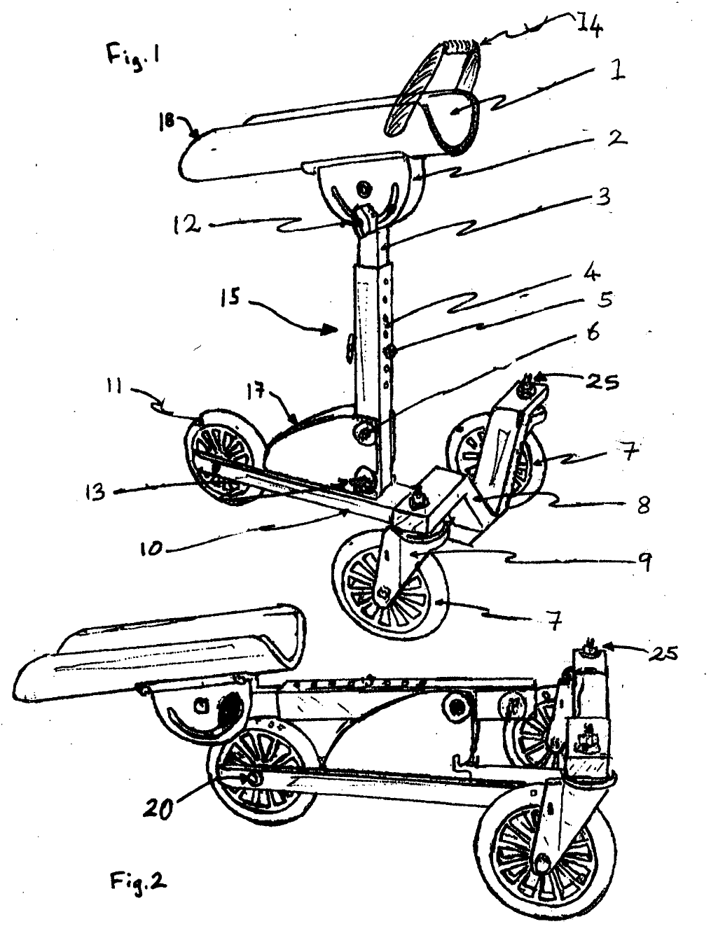

As shown in FIG. 1, the invention is a mobility cart (three-wheeled scooter) (15) having a low center of mass. The low center of mass increases and improves the stability of the three-wheeled scooter. This addresses the problem of instability inferred by the prior art. The preferred embodiment has two anterior wheels (7) mounted on fork axels or casters attached to a cross frame (8) and a third posterior wheel (11) mounted on an axel (20) attached to a base frame (10). The wheels can comprise a rim and a tire. The tire can be manufactured from any durable material, such as polyurethane, rubber, thermoplastic rubber, super tough nylon, or any other suitable material. The tire and/or wheel can be pneumatic, non-pneumatic, or manufactured and/or cast from a solid material. The wheel preferably has a pliable tire, for example, a polyurethane tire or a rubber tire and is of such size that when the wheels are rotated on flat ground or slightly uneven surfaces such as carpet shag, entryway steps, or thresholds, no substantial resistance is encountered. The wheels can be from two inches to about ten inches in diameter, for example, from about 2 inches, 2.5 inches, 3 inches, 3.5 inches, 4 inches, 4.6 inches, 5 inches, 6 inches, 7 inches, 8 inches, 9 inches, 10 inches, or any other standard wheel size. In the alternative, the wheels can be from about fifty millimeters t about two hundred and fifty millimeters in diameter, for example, from about 50 mm, 62.5 mm, 75 mm, 87.5 mm, 100 mm, 112.5 mm, 125 mm, 150 mm, 175 mm, 200 mm, 225 mm, 250 mm, or any other metric wheel size. In a preferred embodiment the wheels are about 5 inches or about 125 mm in diameter.

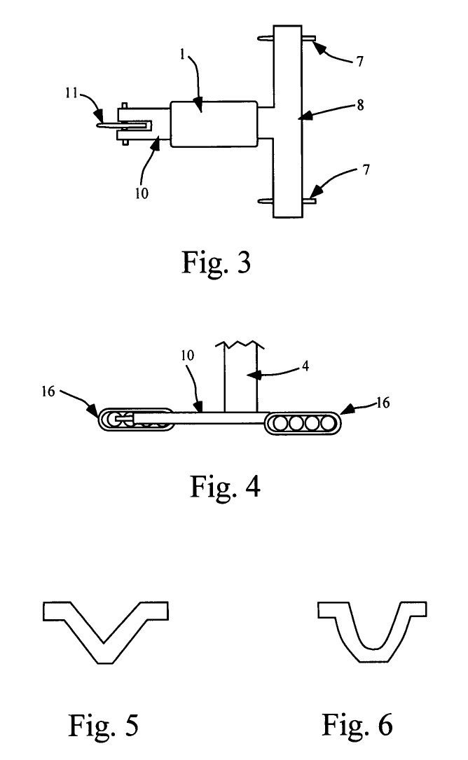

Alternatively, the two wheels (7) can be located at the posterior portion of the scooter and the third wheel (11) located at the anterior portion of the scooter. The base frame is fixedly attached to the median portion of the cross frame. The cross frame and base frame can be two separate items of manufacture or can be manufactured as a single unit. The length of the cross frame can be between about 8 inches and 18 inches, for example, about 8 inches, 9 inches, 10 inches, 11 inches, 12 inches, 13 inches, 14 inches, 15 inches, 16 inches, 17 inches, 18 inches, or any other measurement therebetween. Preferably, the length is about 12 inches. The length of the base frame can be between about 10 inches and 20 inches, for example, about 10 inches, 11 inches, 12 inches, 13 inches, 14 inches, 15 inches, 16 inches, 17 inches, 18 inches, 19 inches, 20 inches, or any other measurement therebetween. Preferably, the length is about 14 inches. As shown in FIG. 3 in a view from above, the frame (8 and 10) can be in the shape of a “T”.

The casters can be attached to the cross frame using, for example, bolts (25) that allow the casters (9) to rotate within a housing, the housing seated within a hollow aperture through the cross frame (8). Those of skill in the art will understand that a number of solutions for attaching a caster to the frame are know and understood to be of utility.

Alternatively, as shown in FIG. 4, caterpillar tracked means (16) can be used in place of or in conjunction with the wheels as disclosed herein.

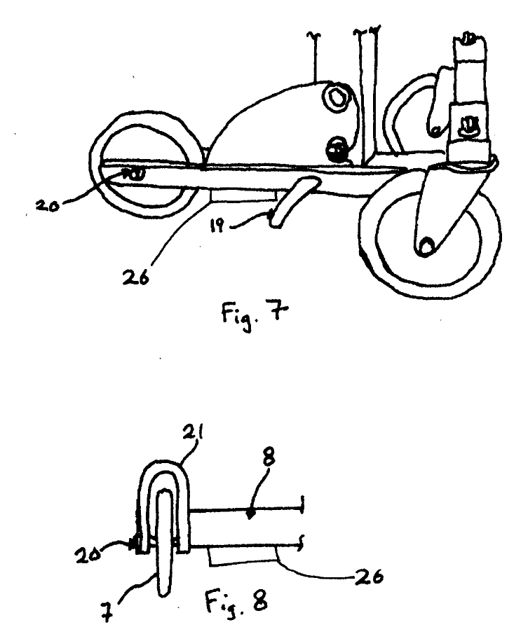

One manner in which the low center of mass is achieved is manufacturing the cross frame in a “V” shape or a “U” shape as shown in FIG. 5 and FIG. 6, respectively. The shape can also be described as a “gull-wing”. The shape results in a larger proportion of the mass to be closer to the surface or ground. In addition the “V” and the “U” shape allow the inclusion of wheels having large diameters. Large wheels roll more easily over the ground or surface and are less susceptible to catching and/or jamming on small particles, flooring transitions, carpeting, rough surfaces, thresholds, or the like.

Another manner to adjust the center of mass can be to include weights that can be inserted and secured into an optional retaining bracket (26) that is attached to or is part of the base frame and/or the cross frame, as illustrated in FIG. 7 and FIG. 8. The weights can be manufactured from lead or other suitable dense element, compound, or material and can be shaped and sized to optimize the mass required to be added to the cart.

The cross frame can alternatively comprise a straight bar, the wheels coupled via an axel (20) and fork member (21), as shown in FIG. 8.

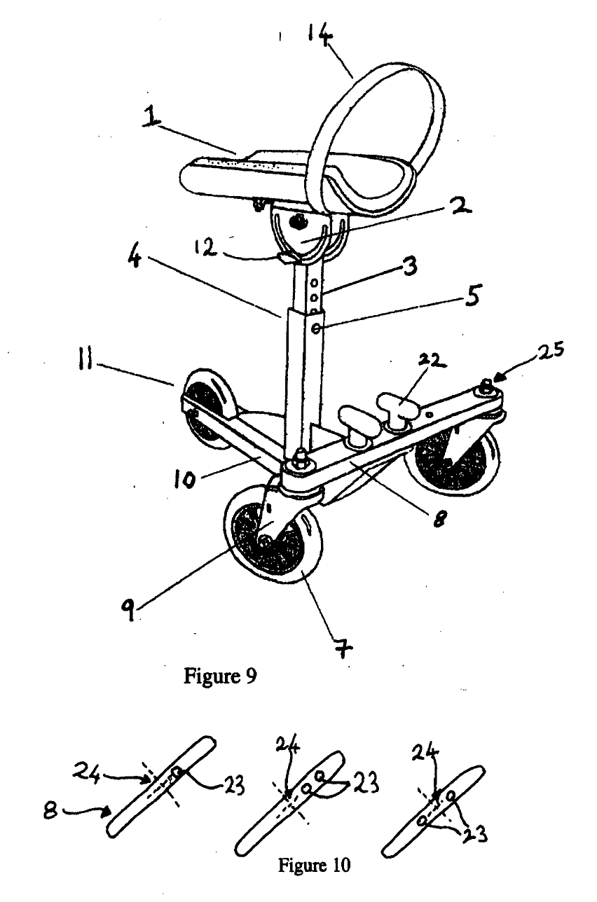

FIG. 9 illustrates an alternative embodiment of the invention, in particular showing the adjustable wheel bar (cross frame) (8), telescoping support (3), sleeve (4), retaining means and knob (22). Two knobs and retaining means are shown. The retaining means and knobs allows a rider or user to position the cross frame relative to the base frame such that the mobility cart is adapted for either supporting the right limb or the left limb. The retaining means are fixed to the base frame via an aperture in the cross frame. Examples of apertures in the cross frame are shown in FIG. 10. FIG. 10A shows a single aperture (23); FIG. 10 B shows two apertures located on the same side of the cross frame relative to the center (24) of the cross frame; FIG. 10C shows two apertures on either side of the center. The apertures can be equally spaced from the center. Alternatively, the apertures can be spaced at different distances from the center.

In one embodiment the aperture is positioned from between about 1 inches, about 1.5 inches, about 2 inches, about 2.5 inches, about 3 inches, about 3.5 inches, or about 4 inches off center or other intervals therebetween. In one preferred embodiment the aperture is about 2.5 inches off center. In an alternative embodiment the aperture is positioned from between about 2 cm, about 2.5 cm, about 3 cm, about 3.5 cm, about 4 cm, about 4.5 cm, about 5 cm, about 5.5 cm, about 6 cm, about 6.5 cm, about 7 cm, about 7.5 cm, about 8 cm, about 8.5 cm, about 9 cm, about 9.5 cm, or about 10 cm off center or other intervals therebetween. In one preferred embodiment the aperture is about 6.5 cm off center. The adjustments allow a rider or user to have more room for the free leg or un-injured leg to by-pass the caster and wheel on that side of the mobility cart, thereby reducing the risk of tripping by catching the free or un-injured limb on the caster and wheel. In addition, this arrangement offers greater stability of the mobility cart and the rider or user, further reducing the risk of tipping or falling over due to lack of equilibrium.

In view of the fact that the human population comprises people having a large range of mass, it may be desirable to manufacture a range of frames having different dimensions. For example, a person weighing about 300 lbs (about 136 kg) would need to use a cart having larger dimensions than a person weighing 75 lbs (about 34 kg). It is therefore desirable to manufacture a more sturdy and/or stable cart to distribute the combined mass over a larger surface area in proportion to the person's mass.

The cross frame and the base frame may be extruded plastic, molded plastic, carbon fiber, aluminum, stainless steel, steel plate, a metal, an alloy, or any other suitable material.

The limb support member can be fixedly attached and secured to the base frame. Preferably, the limb support member is attached and secured proximal to and in the vicinity of the center of mass of the unit. In the alternative, a cart unit that can be folded and/or collapsed for storage and/or transporting, is desirable. In such an alternative, the limb support member can be attached to the base frame using a first bracket (17), swivel bolts (6), and spring-loaded vertical support lock (13), as shown in FIG. 1. In use, the spring-loaded vertical support lock is withdrawn by the user thereby releasing the lock and allowing the limb support member to be rotated approximately ninety degrees to lie in an inclined position proximal to the rear end of the frame and wheel (see FIG. 2). Optionally, the first bracket can also comprise a stop bar that prevents the limb support member from contacting the third wheel when it is in the inclined position. Thus, the cart can still be used by a person in order to provide mobility closer to the ground. This is of particular use when the person wishes or is required to work in, for example, cupboards that are below the standard counter level or the like.

The limb support member can also have an optional telescoping support (3) and sleeve (4) for adjusting the height of the knee support (1). The telescoping support is secured within the sleeve at a desired position using a locking bolt (5) inserted through regularly spaced apertures machined into the telescoping support and sleeve. The apertures can be spaced at regular intervals, for example, at 0.5 inches, at 1 inches, at 1.5 inches, at 10 mm, at 15 mm, at 20 mm, at 25 mm, at 30 mm, at 35 mm, or other intervals therebetween.

The knee support can be fixedly attached and secured to the limb support member. In the alternative, as shown in FIG. 1, the knee support (1) can be secured via a second bracket (2) that allows the user to adjust the angle of the knee support relative to the level of the surface or ground. The knee support can be from between about eight inches to about sixteen inches in length, for example, from about 8 inches, 9 inches, 10 inches, 11 inches, 12 inches, 13 inches, 14 inches, 15 inches, 16 inches, or any other measurement therebetween. Preferably the knee support is about 14 inches in length.

The exterior surface of knee support (1) is padded with foam rubber or any other suitable material and is covered with vinyl or any other suitable material. A flexible lift handle (14) may also be fixedly attached to the knee support and which enables a user to carry the unit from one location to another. Additionally, knee support (1) includes a roughly concave surface (18) for encouraging centering of the non-ambulatory lower leg.

As shown in FIG. 1 and FIG. 2, the second bracket (2) can comprise a pair of curved apertures through which is inserted a locking means (12) such as a locking wing nut, pin, or the like. The angle between the knee support (1) and the second bracket (2) can be adjusted by releasing the locking means, repositioning the bracket relative to the limb support member (3), and relocking the locking means.

Optionally, as shown in FIG. 7, the mobility cart can also comprise at least one outrigger (19) secured to and/or part of the base frame. The outrigger is a safety means and may prevent the unit from overturning should the rider or user and cart become unstable during use. The outrigger can be, for example, between one and three inches in length. The distal part of the outrigger can be several inches above the surface or ground level, thereby allowing passage and movement across the surface or ground without catching or snagging on protrusions.

The three-wheeled cart herein disclosed is inherently more stable that a similar cart with a more elevated center of mass. In this context, the terms “center of gravity” and center of mass” are understood to be interchangeable.

The center of mass can be measured using methods well-known to those in the art, such as by determining the center of balance of a cart or similar device in three planes that are at right-angles to one another.

In the alternative, the center of mass can be measured using instruments well known to those of skill in the art, for example, the KSR Series (Mass Properties) instruments and the like that are available from Space Electronics (81 Fuller Way, Berlin, Conn. 06037, USA).

### LIST OF REFERENCE NUMERALS

1. Limb Support
2. Second Bracket for Angle Adjustment of Limb Support
3. Telescoping Support
4. Sleeve
5. Locking Bolt or Locking Pin
6. Swivel Bolt
7. Wheel
8. Cross Frame
9. Caster
10. Base Frame
11. Wheel
12. Locking Means
13. Spring-loaded Vertical Support Lock
14. Handle
15. Mobility Cart
16. Caterpillar Tracks
17. First Bracket
18. Surface of Limb Support
19. Outrigger
20. Axel
21. Fork Member
22. Knob
23. Aperture
24. Center
25. Caster Bolts
26. Retaining Bracket

Those skilled in the art will appreciate that various adaptations and modifications of the just-described embodiments can be configured without departing from the scope and spirit of the invention. Other suitable techniques and methods known in the art can be applied in numerous specific modalities by one skilled in the art and in light of the description of the present invention described herein. Therefore, it is to be understood that the invention can be practiced other than as specifically described herein. The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

We claim:

1. A mobility cart having a frame, a limb support member coupled to the frame, the frame having a front end and a rear end, and a plurality of wheels coupled to the frame.

2. The mobility cart of claim 1 having a low center of mass.

3. The mobility cart of claim 1 having at least three wheels.

4. The mobility cart of claim 1 further having at least one outrigger coupled to the frame.

5. The mobility cart of claim 1 wherein the diameter of each wheel is selected from the group consisting of 2 inches, 2.5 inches, 3 inches, 3.5 inches, 4 inches, 4.6 inches, 5 inches, 6 inches, 7 inches, 8 inches, 9 inches, and 10 inches.

6. The mobility cart of claim 5 wherein the diameter of each wheel is 5 inches.

7. The mobility cart of claim 3 wherein two wheels are mounted at the front end of the frame and one wheel is mounted at the rear end of the frame.

8. The mobility cart of claim 7 wherein each of the two wheels at the front end of the frame are further mounted on a caster attached to the frame.

9. The mobility cart of claim 7 wherein the wheel mounted on the rear end of the frame is mounted on an axel attached to the frame.

10. The mobility cart of claim 7 wherein each of the two wheels at the front end of the frame are mounted on an axel attached to the frame.

11. The mobility cart of claim 1 wherein the wheels are sealed bearing wheels.

12. The mobility cart of claim 1 wherein the frame comprises a cross frame and a base frame.

13. The mobility cart of claim 12 wherein the cross frame comprises a “V” shape.

14. The mobility cart of claim 12 wherein the cross frame comprises a “U” shape.

15. The mobility cart of claim 1 wherein the limb support member comprises a telescoping support and a sleeve.

16. The mobility cart of claim 1 wherein the limb support member comprises a limb support.

17. The mobility cart of claim 18 further comprising a handle, the handle fixedly attached to the limb support.

18. The mobility cart of claim 1 further comprising a first bracket interposed between the frame and the limb support member.

19. The mobility cart of claim 15 wherein the first bracket is adjustable.

20. The mobility cart of claim 1 wherein the limb support member further comprises a second bracket and a padded limb support cover.

21. The mobility cart of claim 17 wherein the second bracket is adjustable.

22. The mobility cart of claim 18, wherein the adjustable bracket is positioned between the limb support and the telescoping support.

23. The mobility cart of claim 12 further comprising at least one aperture, the aperture shaped and adapted for receiving retaining means.

24. The mobility cart of claim 20 further comprising retaining means.

25. The mobility cart of claim 21 wherein the retaining means further comprise at least one knob.

26. The mobility cart of claim 1 further comprising at least one retaining bracket.

27. A method for supporting and mobilizing a person having a lower limb impairment, the method comprising the steps of (i) providing the mobility cart of claim 1, (ii) placing the impaired lower limb of the person upon the limb support member, (iii) pushing the mobility cart using an un-impaired lower limb, thereby supporting and mobilizing the person having a lower limb impairment.
